(19) United States
(12) Patent Application Publication
(10) Pub. No.: US 2002/0079146 A1
(43) Pub. Date: Jun. 27, 2002

(54) Motor mount of electric cart

(76) Inventor: Tsang-Ying Chen, Chang Hua Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/741,056

(22) Filed: Dec. 21, 2000

(51) Int. Cl. B60K 1/00

(52) U.S. Cl. 180/65.1; 180/291

(57) ABSTRACT

An electric cart is provided with a motor mount for locating securely the motor of the electric cart. The motor mount is formed of a fitting tube, a connection portion extending from the fitting tube, and a fastening ring disposed at the free end of the connection portion. The fitting tube is fitted over the shaft tube in which the axle of two rear wheels of the electric cart is received. The fastening ring is fastened with the motor such that the spindle of the motor is received in the fastening ring.

### FIELD OF THE INVENTION

The present invention relates generally to an electric cart, and more particularly to a motor mount of the electric cart.

### BACKGROUND OF THE INVENTION

As shown in FIG. 1, an electric cart 1 of the prior art comprises a body frame 2, a handlebar frame 3 mounted at the front end of the body frame 2, a front wheel 4 pivoted to the bottom end of the handlebar frame 3, a shaft 5 disposed at the rear end of the body frame 2, an axle 6 put through the shaft 5, two rear wheels 7 fastened with two ends of the axle 6, a motor mount 8 disposed on the shaft 5, and a motor 9 mounted on the motor mount 8 for driving the axle 6 to turn. The motor mount 8 is of a rectangular cubic construction and is provided in the bottom with a semicircular slot 81. As a result, the motor mount 8 can not be secured in place. In addition, the axle 6 is susceptible to vibration.

### SUMMARY OF THE INVENTION

The primary objective of the present invention is to provide an electric cart with a motor mount capable of securing the motor of the electric cart in place. The electric cart is similar in construction to the prior art electric cart described above, except that the motor mount of the present invention comprises a fitting tube fitted over the shaft, a connection portion extending radially from the fitting tube, and a fastening ring disposed at the free end of the connection portion for fastening the motor such that the spindle of the motor is received in the fastening ring.

### BRIEF DESCRIPTION OF THE DRAWINGS

FIG. 1 shows a side view of an electric cart of the prior art.

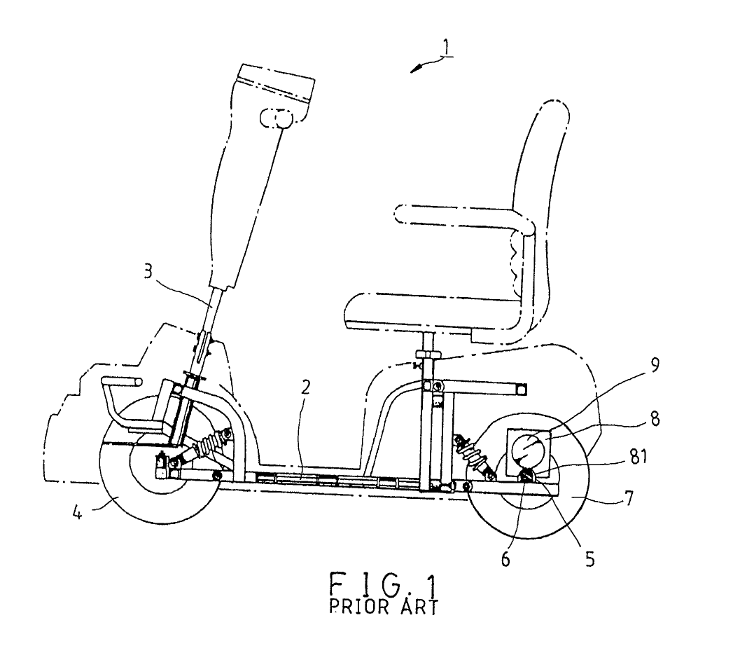

FIG. 2 shows a side view of an electric cart of a preferred embodiment of the present invention.

FIG. 3 shows a front view of the preferred embodiment of the present invention.

FIG. 4 shows a side view of the preferred embodiment of the present invention.

FIG. 5 shows a side view of the motor mount of the preferred embodiment of the present invention.

### DETAILED DESCRIPTION OF THE INVENTION

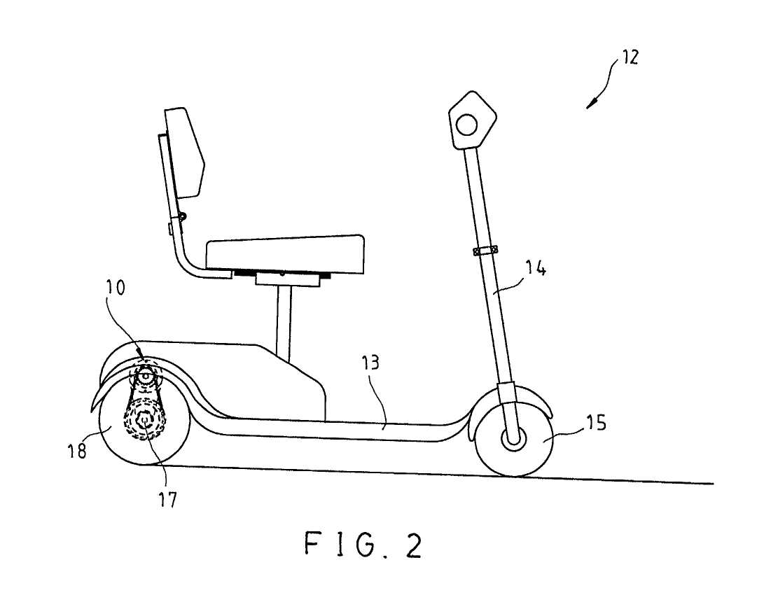

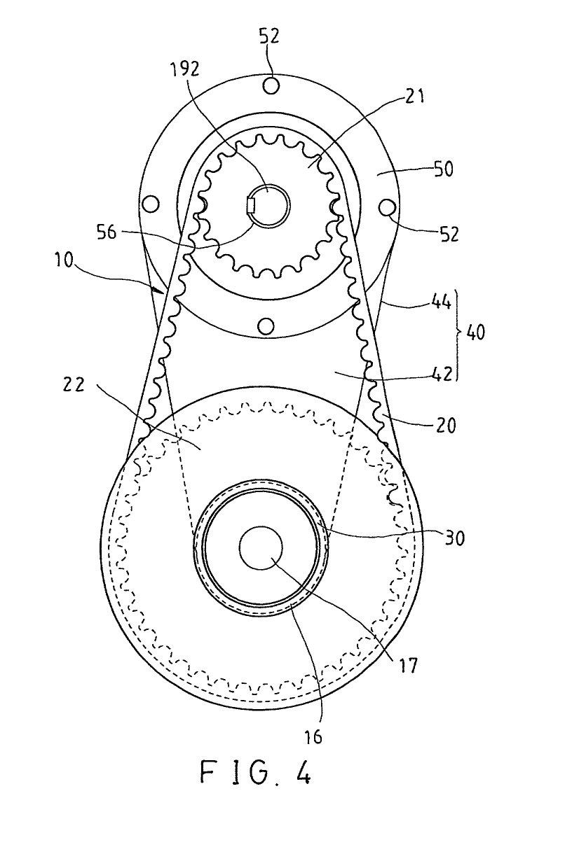

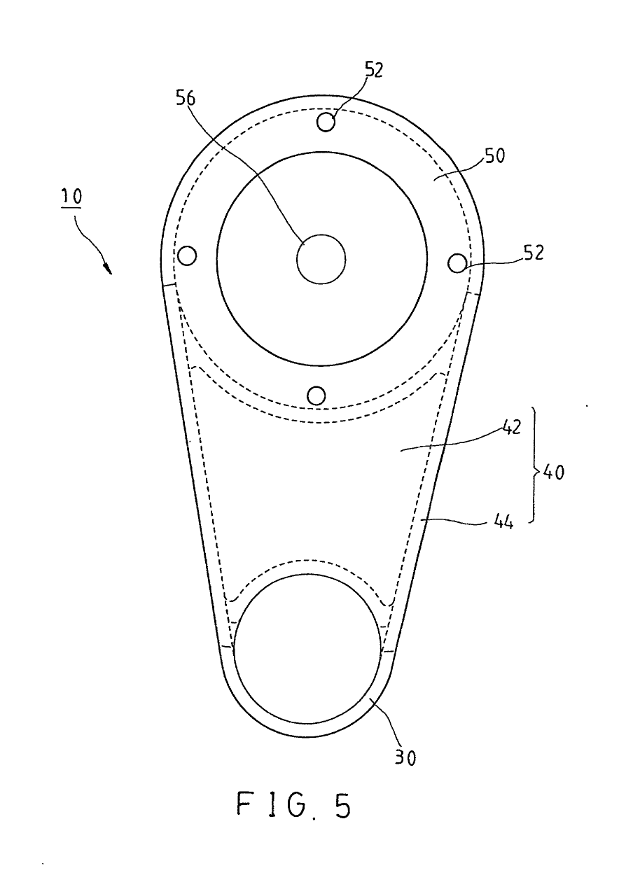

As shown in FIGS. 2-5, an electric cart 12 of the present invention comprises a body frame 13, a handlebar frame 14 rotatably mounted at the front end of the body frame 13, a front wheel 15 pivoted to the bottom end of the handlebar frame 14, a shaft tube 16 disposed horizontally at the rear end of the body frame 13, an axle 17 received in the shaft tube 16, two rear wheels 18 mounted on two ends of the axle 17, a motor mount 10 disposed on the shaft tube 16, and a motor 19 mounted on the motor mount 10 for driving a drive wheel 21 and a driven wheel 22 via a transmission belt 20.

The motor mount 10 comprises a fitting tube 30, a connection portion 40, and a fastening ring 50.

The fitting tube 30 is fitted over the shaft tube 16 in such a manner that the inner wall of the fitting tube 30 is in an intimate contact with the outer wall of the shaft tube 16.

The connection portion 40 is vertically extended from the fitting tube and is U-shaped in its cross section. The connection portion 40 is formed of a main body 42 and two side wings 44. Both main body 42 and the side wings 44 are of a tapered construction.

The fastening ring 50 is fastened with one end of the connection portion 40 such that the center line of the fastening ring 50 is parallel to the center line of the connection portion 40. The fastening ring 50 is provided with a plurality of threaded holes 52 for fastening the motor 19 with the fastening ring 50 by a plurality of fastening bolts 54 which are engaged with the threaded holes 52 of the fastening ring 50 and the threaded holes (not shown in the drawings) of the motor 19. The motor 19 has a spindle 192, which is received in the through hole 56 of the fastening ring 50 and is fastened with the drive wheel 21.

The motor mount 10 is integrally made of a metal material, such as aluminum alloy. In light of a predetermined length of the fitting tube 30 of the motor mount 10 and the center lines of the fastening ring 50 and the fitting tube 30 being parallel to each other, the center line of the fastening ring 50 is parallel to the shaft tube 16. In the meantime, the spindle 192 of the motor 19 is located at a correct position parallel to the axle 17. As a result, the motor 19 is securely located in place by the motor mount 10.

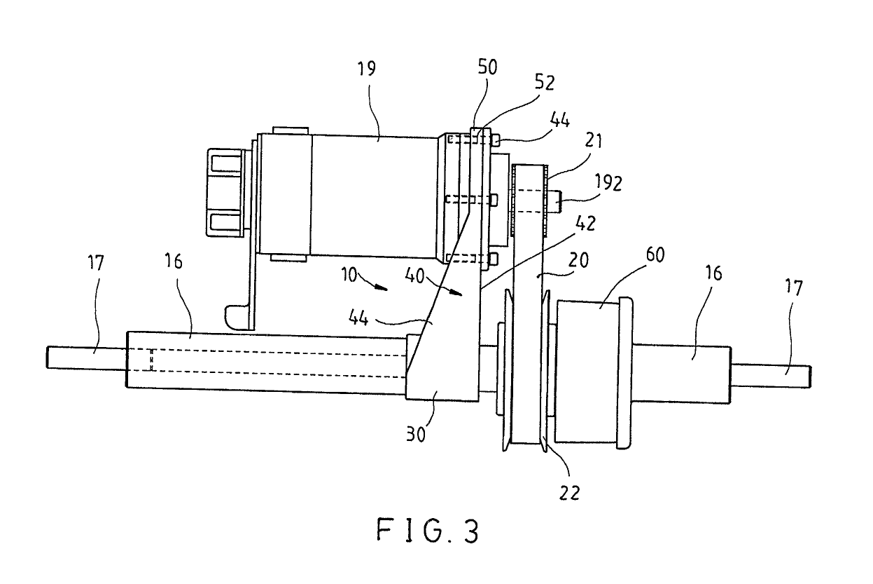

As shown in FIG. 3, the axle 17 is divided into two sections, which are connected by a differential 60. The shaft tube 16 may be divided into two sections, which are fastened with the body frame 13. The axle 17 is driven by the motor 19 via the differential 60. As a result, the two rear wheels 18 turn at different speeds at the time when the electric cart 12 is negotiating a curve.

What is claimed is:

1. A motor mount of an electric cart comprising a body frame, a handlebar frame fastened with the front end of the body frame, a front wheel pivoted to the bottom end of the handlebar frame, a shaft tube disposed at the rear end of the body frame, an axle received in the shaft tube, two rear wheels mounted on two ends of the axle, and a motor mounted on said motor mount, said motor mount comprising:
a fitting tube fitted over the shaft tube;
a connection portion of a predetermined length and extending from said fitting tube such that said connection portion is perpendicular to said fitting tube; and
a fastening ring disposed at a free end of said connection portion for fastening the motor in such a way that the spindle of the motor is received in said fastening ring.

2. The motor mount as defined in claim 1, wherein said fastening ring is provided with a plurality of threaded holes and is fastened with the motor by a plurality of fastening bolts which are engaged with said threaded holes of said fastening ring and the threaded holes of the motor.

3. The motor mount as defined in claim 1, wherein said connection portion has a U-shaped cross section.

4. The motor mount as defined in claim 1, wherein said fitting tube is fitted over the shaft tube in such a fashion that the inner wall of said fitting tube is in an intimate contact with the outer wall of the shaft tube.

5. The motor mount as defined in claim 1, wherein said fitting tube, said connection portion, and said fastening ring of said motor mount are integrally made of a metal material.
